(19) United States
(12) Patent Application Publication
(10) Pub. No.: US 2003/0179871 A1
(43) Pub. Date: Sep. 25, 2003

(54) Data processing apparatus and data processing method

(75) Inventors: Takehiko Ito, Miyagi (JP); Kentaro Fukami, Saitama (JP); Hideki Kasai, Saitama (JP); Naoki Sutoh, Saitama (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/368,645

(22) Filed: Feb. 20, 2003

(30) Foreign Application Priority Data
Mar. 19, 2002 (JP) 2002-077210

(51) Int. Cl. G09G 5/02; H04M 11/00

(52) U.S. Cl. 379/93.24; 345/699; 379/93.17

(57) ABSTRACT

A data processing apparatus, capable of guaranteeing display operations when a destination terminal is a portable terminal apparatus, while the display operations are adapted to display capability of this portable terminal apparatus. The data processing apparatus includes a storage which stores first data therein, a convert section for converting the first data into second data, and a transmit section which transmits the second data to the destination. A judgment is made whether a destination is a portable terminal apparatus. When the destination is judged to be portable terminal apparatus, the convert section converts the first data into the second data based upon display capability of a data display apparatus of the data display apparatus.

### BACKGROUND OF THE INVENTION

1. Field of the Invention

The present invention is related to a technique for transmitting image data and the like. More specifically, the present invention is directed to a data processing apparatus, and a data processing method, capable of guaranteeing display operations when a destination terminal is a portable terminal apparatus, while the display operations are adapted to display capability of this portable terminal apparatus.

2. Background Art

Various techniques are known in the field, by which original image data produced by optically reading originals are transmitted via a network such as the Internet, while these original image data are attached to electronic mails. For instance, facsimile apparatus equipped with electronic mail communication functions can transmit contents of electronic mails byway of facsimile communications, and also can transmit facsimile data by way of electronic mails. On the other hand, in portable terminal apparatus known as portable telephones and personal digital assistants (PDAs), display screens thereof are restricted, and even if original images may be directly received, readabilities of the original images by the portable terminal apparatus are considerably deteriorated. For instance, since only a portion of an entire image is merely displayed on a display screen, a user can immediately and hardly recognize that what sort of image is received by overlooking the entire image.

### SUMMARY OF THE INVENTION

The present invention has been made to solve the above-described problem, and therefore, has an object to provide a data processing technique capable of recognizing that what sort of images are received even when original image data and the like are transmitted to a portable terminal apparatus.

In accordance with the present invention, structural elements described in claims are employed in order to achieve the above-described object. In this case, descriptions made in claims will now be supplementarily explained prior to detailed explanations of the present invention.

That is to say, in accordance with one aspect of the present invention, in order to achieve the above-described object, the invention provides a data processing apparatus for transmitting data including a storage which stores first data therein; a convert section which converts the first data into second data when a judgment is made that a destination is a portable terminal apparatus; and a transmit section which transmits the second data to the destination; wherein the convert section converts the first data into the second data based upon display capability of a data display apparatus of the data display apparatus.

In this arrangement of the data processing apparatus, since the data adapted to the display capability of the portable terminal apparatus is transmitted to this portable terminal apparatus, the image data can be easily handled in the portable terminal apparatus.

In this arrangement of the data processing apparatus, even after the second data has been transmitted, the first data may be stored. In this case, when the content of the second data is unclear, the first data may be again acquired by either the portable terminal apparatus itself, or another terminal having superior display capability so as to view the content of this first data.

Also, the data processing apparatus may alternatively judge that the above-described destination corresponds to the portable terminal apparatus based upon such an information for indicating as to whether or not the destination is such a portable terminal apparatus defined in correspondence with the address. Alternatively, the data processing apparatus may judge that the destination corresponds to the portable terminal apparatus in accordance with a domain name of the above-described address.

The data processing apparatus for transmitting the data according to the present invention is, for instance, an electronic mal communication apparatus, and is more preferably such a facsimile apparatus having an electronic mail communication function. Apparently, this data processing apparatus of the present invention may be applied to various apparatus and systems capable of transmitting data, may be applied to various combinations of these apparatus, and further, may be applied to domestic electric appliances having communication functions.

Also, in accordance with another aspect, the invention provides a data processing apparatus including: a display; a receive section which receives first data; a storage which stores the first data received by the receive section; and a convert section which converts the first data into second data based upon display capability of the display; wherein the display displays the second data.

In this data-receiving data processing apparatus, data can be displayed under such a condition that this data is adapted to display capability of a data reception side.

Also, according to a further aspect, the present invention provides a data processing apparatus including: a receive section which receives first data; a storage which stores the first data received by the receive section; a convert section which converts the first data into second data; and a transmit section which transmits the second data to a transmission determination apparatus; wherein the convert section converts the first data into the second data based upon data display capability of the transmission destination apparatus.

Also, in this arrangement of the data processing apparatus, since the data adapted to the display capability of the portable terminal apparatus is transmitted to this portable terminal apparatus, the image data can be easily handled in the portable terminal apparatus.

In this arrangement of the data processing apparatus, even after the second data has been transmitted, the first data may be stored. In this case, when the content of the second data is unclear, the first data may be again acquired by either the portable terminal apparatus itself, or another terminal having superior display capability so as to view the content of this first data.

Also, the data processing apparatus may alternatively judge that the above-described destination corresponds to the portable terminal apparatus based upon such an information for indicating as to whether or not the destination is such a portable terminal apparatus defined in correspondence with the address. Alternatively, the data processing apparatus may judge that the destination corresponds to the portable terminal apparatus in accordance with a domain name of the above-described address.

It should be understood that the present invention may be realized in the form of either an apparatus or a system, but also may be realized in the form of a method. Apparently, a portion of the present invention may be constituted as software. Also, a software product (recording medium) which is employed so as to cause a computer to execute such a software may be apparently covered in the technical scope of the present invention.

The above-described apparatus according to the above-explained aspects of the present invention and other aspects thereof are described in a scope of claims for a patent, and will be explained in detail by employing embodiments.

### BRIEF DESCRIPTION OF THE DRAWINGS

The present invention may be more readily described with reference to the accompanying drawings, in which:

FIG. 1 is an explanatory diagram for explaining a network environment of a data processing apparatus according to an embodiment of the present invention.

FIG. 2 is a block diagram for schematically showing an arrangement of the data processing apparatus according to this embodiment.

FIG. 3 is an explanatory diagram for explaining a destination table of the embodiment.

FIG. 4 is an explanatory diagram for explaining a domain name correspondence table of the embodiment.

FIG. 5 is a block diagram for schematically showing an arrangement of a portable telephone according to a modification of the above-described embodiment.

FIG. 6 is a block diagram for schematically representing an arrangement of a mail server according to another modification of the above-explained embodiment.

FIG. 7 is a flow chart for describing operations of a further modification of the above-described embodiment.

FIG. 8 is an explanatory diagram for explaining an improvement of the above-described destination table.

FIG. 9 is a flow chart for explaining an improvement of the above-described destination table.

### DETAILED DESCRIPTION OF THE PREFERRED EMBODIMENTS

Embodiment of the present invention will now be described as follows:

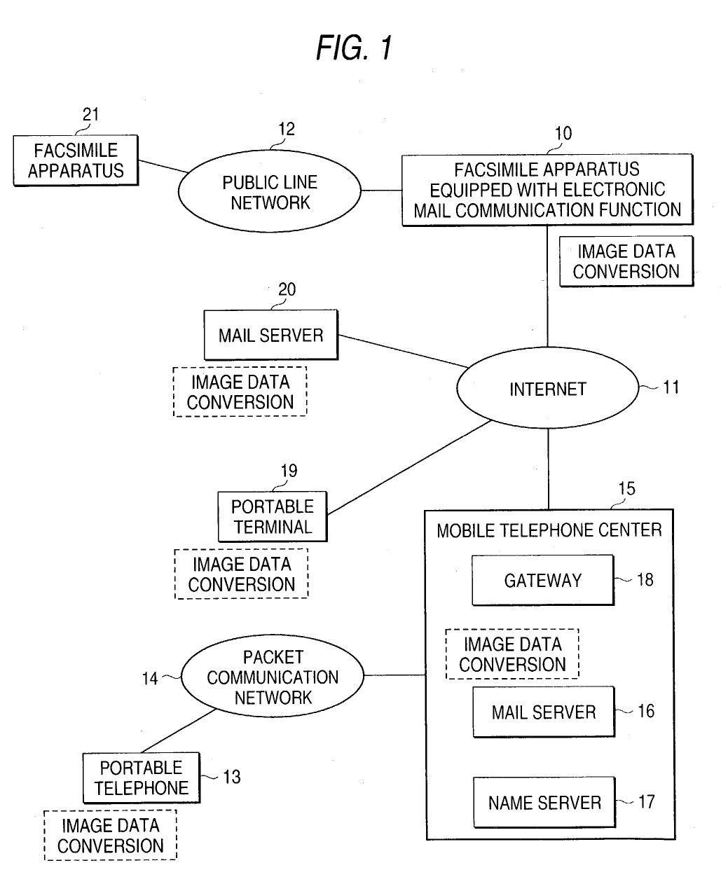

FIG. 1 represents a network environment of this embodiment. In this drawing, a facsimile apparatus 10 equipped with an electronic mail communication function is capable of performing both an electronic mail communication and a facsimile communication, and is connected to both the Internet 11 and a public line network 12. A portable telephone 13 owns an electronic mail communication function, and furthermore, can transmit/receive image data by way of an electronic mail communication. This portable telephone 13 is connected via a packet communication network 14 to a mobile telephone center 15. The mobile telephone center 15 contains a mail server 16, a name server 17, a gateway 18, and the like. The mail server 16 provides mail communication services with respect to the portable telephone 13. The mail communication services may be realized by, for instance, an SMTP service function and a POP service function. The mobile telephone center 15 is connected via the gateway 18 to the Internet 11. A portable terminal 19 is connected via a predetermined communication resource to the Internet 11. This portable terminal 19 receives mail services from a predetermined mail server 20 provided on the Internet 11. Also, another facsimile apparatus 21 is connected to the public line network 12.

In this example, the facsimile apparatus 10 equipped with the electronic mail function transmits original image data via the Internet 11 and the mobile telephone center 15 to the mail server 16 of this mobile telephone center 15 by way of an electronic mail communication. The portable telephone 13 receives the original image data as an electronic mail via the packet communication network 14 from the mail server 16.

Similarly, the facsimile apparatus 10 equipped with the electronic mail communication function transmits the original image data via the Internet 11 to the mail server 20 by way of the electronic mail communication. The portable terminal 19 accesses via the Internet 11 to the mail server 20 so as to receive the original image data as an electronic mail.

In this example, in such a case that a transmission destination of the original image data corresponds to a portable terminal apparatus (namely, portable telephone 13 and portable terminal 19), the facsimile apparatus 10 equipped with the electronic mail converts this original image data so as to be adapted to a display size (image display capability) of this portable terminal apparatus, and then, transmits the converted original image data. Alternatively, the facsimile apparatus 10 equipped with the electronic mail communication function may convert the original image data in adaptation with other image display capability such as a monochrome, a color, a file type, and decoding of an image.

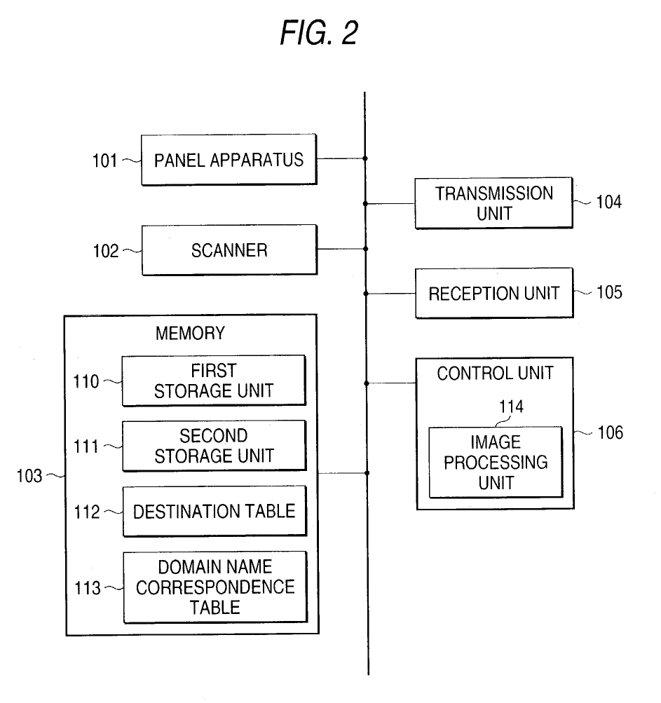

FIG. 2 schematically shows the facsimile apparatus 10 equipped with the electronic mail communication function of this embodiment. In this drawing, the facsimile apparatus 10 equipped with the electronic mail communication function contains a panel apparatus 101 for instructing an input, a scanner 102 for reading an original image, a memory 103, a transmission unit 104, a reception unit 105, a control unit 106, and the like. The transmission unit 104 executes a facsimile transmission operation and an electronic mail transmission operation. The reception unit 105 executes a facsimile reception operation and an electronic mail reception operation. The control unit 10 controls an entire appliance main body of this facsimile apparatus 10. The memory 103 is arranged by containing a RAM, a ROM, a hard disk drive, and the like. This memory 103 owns a first storage unit 110, a second storage unit 111, a destination table 112, and a domain name correspondence table 113. The control unit 106 is provided with a CPU and the like. In this example, the control unit 106 may also constitute an image processing unit 114. It should be noted that such an image processing unit may be separately constituted with respect to the control unit 106. It should also be understood that electronic mail communications will be mainly explained in the below-mentioned descriptions. Apparently, facsimile communications may be carried out in the well known mode.

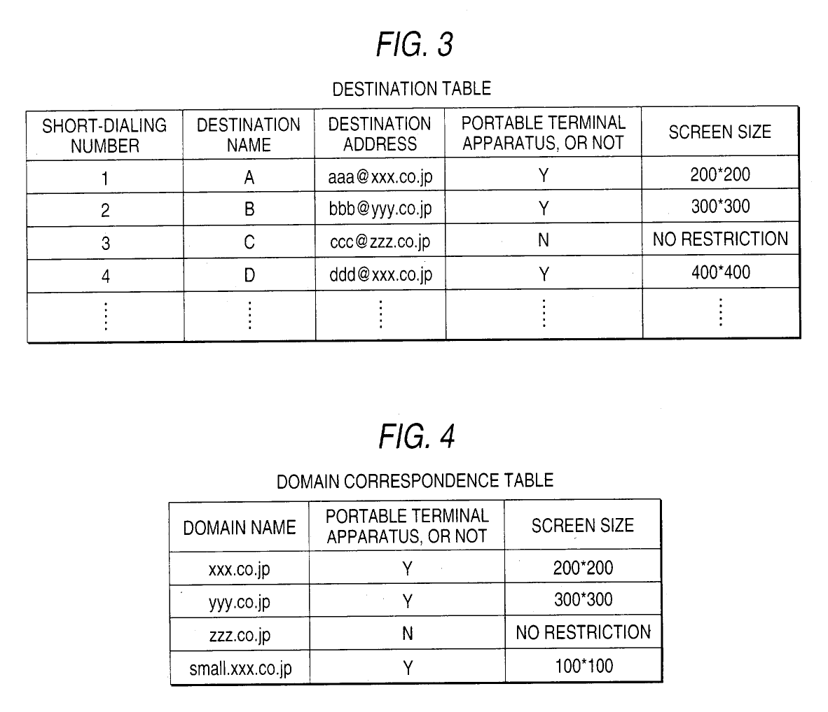

Next, a description will now be made of a destination designation executed when the facsimile apparatus 10 equipped with the electronic mail transmits an electronic mail. A destination of an electronic mail is entered by employing the panel apparatus 101. In this example, for example, as indicated in FIG. 3, a destination table 112 stores there into short-dialing numbers, destination names, destination addresses, flags indicating as to whether or not destination terminals are portable terminal apparatus, screen sizes, and so on. A destination is designated by inputting a short-dialing number from the panel apparatus 101. For example, when a short-dialing number 1 is entered from the panel apparatus 101, the following items may be grasped: The destination address is “aaa@XXX.co.jp”, the destination terminal is a “portable terminal apparatus”, and the screen size is “200×200.”

Also, as shown in FIG. 4, a domain name correspondence table 113 is separately provided with respect to the above-explained destination table. This domain name correspondence table 113 holds flags and screen sizes. The flags indicate as to whether or not the respective domain names correspond to portable terminal apparatus. A domain name implies a domain name portion of a destination: a subject domain name portion, or a sub-domain name portion, which is described in an MX record of a domain name system, namely a portion subsequent to a mark “@.” Since this domain name correspondence table 113 is employed, such information may be acquired from a domain name portion of a destination of an electronic mail, namely as to whether or not a destination terminal corresponds to a portable terminal apparatus, and a display size.

For instance, when “aaa@XXX.co.jp” is entered from the panel apparatus 101, an operator consults the domain name correspondence table 113 and thus, can understand that a destination apparatus (destination terminal) corresponds to a portable terminal apparatus, and a screen size thereof corresponds to “200×200.”

[symbol]

If the domain name correspondence table 113 is employed, then display capability of a destination as to such an address which is not registered in the destination table 112 may be judged. In such a case that both data of display capability registered in the destination table 112 and data of display capability of the domain name correspondence table 113 can be entered, any one of these display capability data may be employed in the highest priority.

Next, a transmission of an original image will now be described.

(1). Either a short-dialing member or an individual address is entered from the panel apparatus 101 so as to designate a destination. An operator consults either the destination table 112 or the domain name correspondence table 113, and thus, can grasp as to whether or not a destination apparatus corresponds to a portable terminal apparatus. Also, when the destination terminal corresponds to the portable telephone apparatus, the operator can grasp a screen size of this portable terminal apparatus.

(2). An original image is read from the scanner 102 and then the read original image data is stored in the first storage unit 110.

(3). In such a case that the destination terminal does not correspond to the portable terminal apparatus, image data stored in the first storage unit 110 is converted into such an image data of an electronic mail format, and then, this mail-formatted image data is transmitted as an electronic mail to a destination address.

(4). When the destination terminal corresponds to the portable terminal apparatus, a pixel number (resolution) of image data stored in the first storage unit 110 is compressed in such a manner that the size of this image data is fitted to a screen size of this destination terminal. Then, the compressed image data is stored in the second storage unit 111, and thereafter, this image data is converted into such an image data having an electronic mail format, and then, this mail-formatted image data is transmitted as an electronic mail to a destination address. The compression of the image data is carried out in the image processing unit 114.

In this example, for example, in the case that original image data is transmitted as an electronic mail to the portable telephone 13, since the domain names of the mobile telephone center 15 are registered in a batch manner into the domain name correspondence table 113 as domain names used for portable terminal apparatus, this original image data may be transmitted as such an image whose size is fitted for the screen size of the portable telephone 13. Similarly, in such a case that a domain name of the mail server 20 of the portable terminal 19 is made different from a domain name of the normal service, since this domain name is registered into the domain name correspondence table 113, the original image data can be transmitted as such an image whose size is fitted for the screen size of the portable terminal 19. As to this domain name of the mail server 20, for instance, while a sub-domain name of the mail server 19 for a portable terminal of an Internet provider is assumed as “AAA-Mobile”, a sub-domain name of a mail server of another communication terminal is “AAA-PC.”

As apparent from the foregoing description, as indicated in FIG. 3, while both the information of the portable telephone 13 and the information of the portable terminal 19 are registered in the destination table, such images whose sizes are adapted to the respective screen sizes of the portable telephone 13 and the portable terminal 19.

It should be understood that since a compressed image is viewed in either the portable telephone 13 or the portable terminal 19, a detailed portion of this compressed image becomes unclear, but an important degree of this compressed image may be judged by overlooking at least the entire compressed image. As a consequence, an original image of this overlooked image may be acquired, if necessary. Alternatively, while original image data is stored in the facsimile apparatus 10 equipped with the electronic mail communication function, the original image data may be resent in response to a request issued from the portable telephone 13, or the like. Further, the original image data may be transmitted to a designated personal computer and/or a designated facsimile apparatus.

As previously explained, in accordance with the data processing apparatus of this embodiment, such an image data is compressed (namely, reduction of pixel number, lowering of resolution) and then the compressed image data is transmitted to the portable terminal apparatus, while there is a certain difficulty that this image data is directly transmitted thereto due to a certain restriction of a screen size of the portable terminal apparatus. As a result, a content of this compressed image can be simply and immediately grasped. Also, the communication cost, the communication time, and the process time of this image data can be reduced.

It should also be understood that the present invention is not limited to the above-described embodiment, but may be modified without departing from the technical scope and spirit. For instance, the image data is not compressed, but also may be converted in adaptation with display capability of portable terminal apparatus such as color/monochrome, decoding systems, and the like.

Also, in the above-explained embodiment, the facsimile apparatus equipped with the electronic mail communication function has been exemplified. Apparently, the present invention may be widely applied when an electronic mail is transmitted by the normal mail user agent apparatus. Alternatively, the present invention may be applied not only to such a case that image data is directly from the facsimile apparatus equipped with the electronic mail communication function, but also to the case that when the facsimile apparatus equipped with the electronic mail communication function is employed as a repeating apparatus, image data may be converted within a repeating path thereof.

Also, as indicated by a broken line in FIG. 1, since image data converting functions are employed in the portable telephone 13, the portable terminal 19, the mail server 16, and the mail server 20 (mail transfer agent apparatus), the present invention maybe applied to a portable terminal apparatus and a mail server.

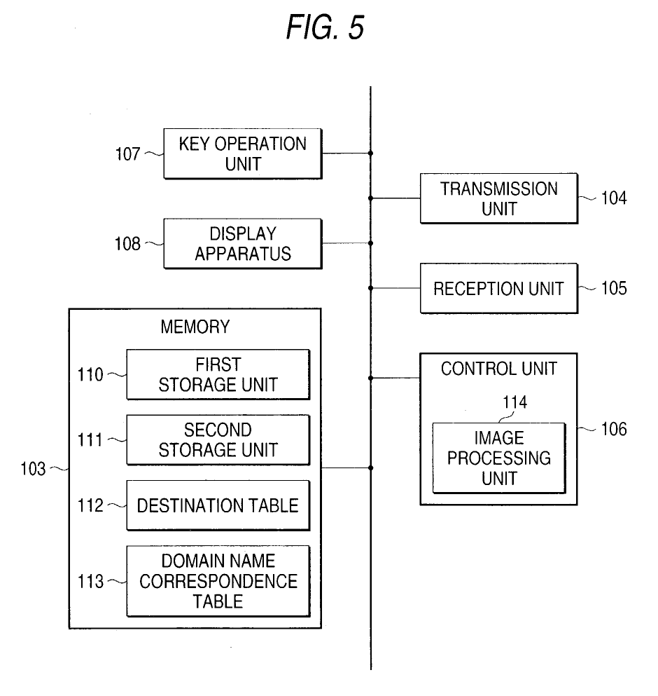

FIG. 5 represents an arrangement constructed by that the present invention is applied to the portable telephone 13. It should be noted that the same reference numerals shown in FIG. 2 will be employed as those for denoting the same, or similar structural elements indicated in this drawing, and explanations thereof are omitted. In FIG. 5, both a key operation unit 107 and a display apparatus 108 (liquid crystal display apparatus) are provided.

This portable telephone 13 may receive an electronic mail containing image data, and then, may display this image on a display screen of the display apparatus 108. It is so assumed that a size of such a pixel number made by (200×200) pixels can be displayed on this display screen. The control unit 106 analyzes the image data of the received electronic mail, and then, converts the image data into such an image data having a size of (200×200) pixels based upon the analysis result. For example, the control unit 106 compresses image data having a size of (1000×1000) pixels into such an image data having a size of (200×200) pixels. As a result, even when such an image could not be originally displayed one time, this image may be displayed one time and thus may be easily handled.

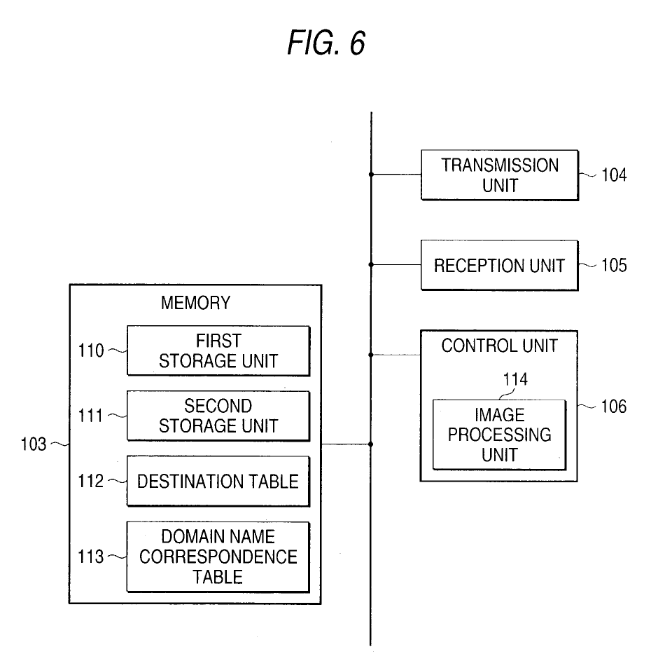

FIG. 6 indicates an arrangement in which the present invention has been applied to the mail server 16. It should also be noted that the same reference numerals indicated in FIG. 2 will be employed as those for representing the same, or similar structural elements shown in this drawing, and therefore, explanations thereof are omitted. It should also be understood that the arrangement of FIG. 6 may correspond to such a mail server which has been firstly required to transfer an electronic mail from a mail sender (namely, mail transfer agent apparatus), or may correspond to another mail server located just before a destination (namely, mail transfer agent apparatus), otherwise a mail server for repeating an electronic mail. The first-mentioned mail server is such a server which is required to transfer an electronic mail from a transmission client, whereas the second-mentioned mail server is such a server which is required to derive an electronic mail from a reception client. Also, the destination correspondence table 112 holds correspondence relationships between destination addresses and attributes (whether or not destination terminal is portable terminal apparatus, and screen size) of display capability of destination terminals. Optional conditions may be added to data converting operations in response to setting conditions every client. For instance, as an optional condition, an SMTP server which receives a mail transfer request from a transmission client may describe such an optional condition as to whether or not a data converting operation is carried out every client. Also, a POP (IMAP) server which receives a mail read request from a reception client may describe how to execute a data converting operation every client.

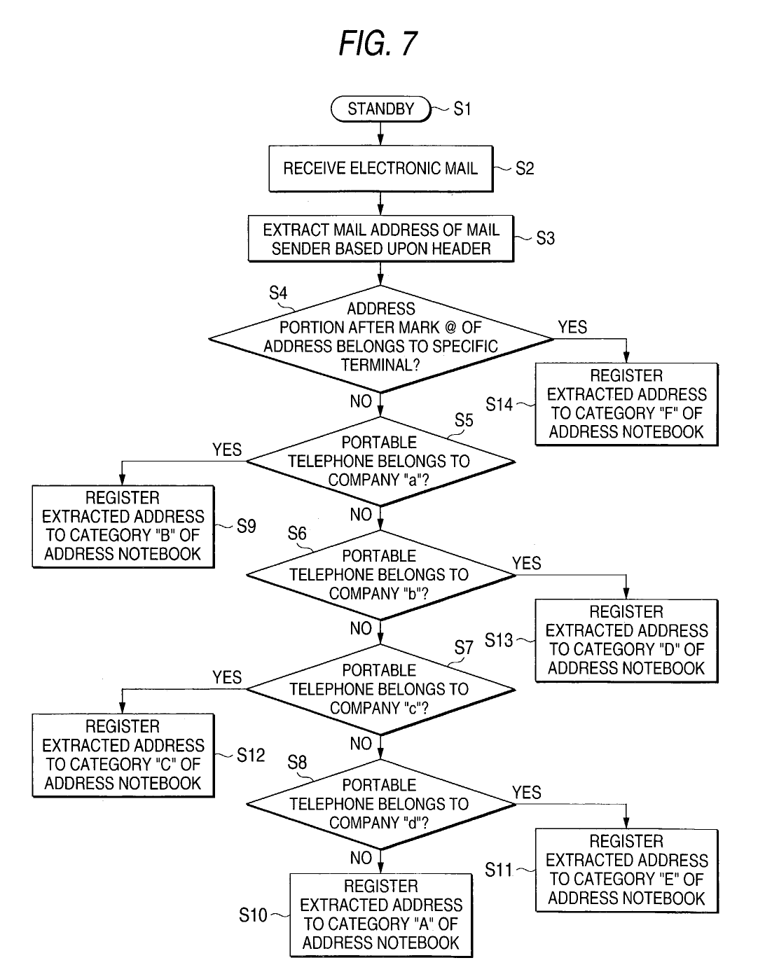

Alternatively, in an electronic mail communication apparatus (including facsimile apparatus equipped with electronic mail communication function), a sender of a received electronic mail is automatically registered in a destination table (will also be called as “address notebook”, or “electronic address notebook”), and at this time, a domain name of the received electronic mail may be detected and then display capability corresponding to this detected domain name may be registered in the destination table. In this case, when the domain name is such a domain name which is specifically owned by a portable telephone service provider, the display capability thereof may be directly judged. Also, a specific domain name may be judged based upon individual information as a domain name of a portable terminal apparatus. This domain judgment flow operation is represented in FIG. 7. In this example, while categories A, B, C, D are allocated to portable telephone service providers “a”, “b”, “c”, “d”, both display capability thereof and expansion capability thereof are registered. Also, as to a separately set domain name, the corresponding category (“F” in this case) is applied thereto. Alternatively, various categories may be newly set to domain names, so that individual display capability may be applied thereto. It should be understood that since contents of the flow operations of FIG. 7 are apparently understandable, no detailed explanations thereof are specifically made in this embodiment.

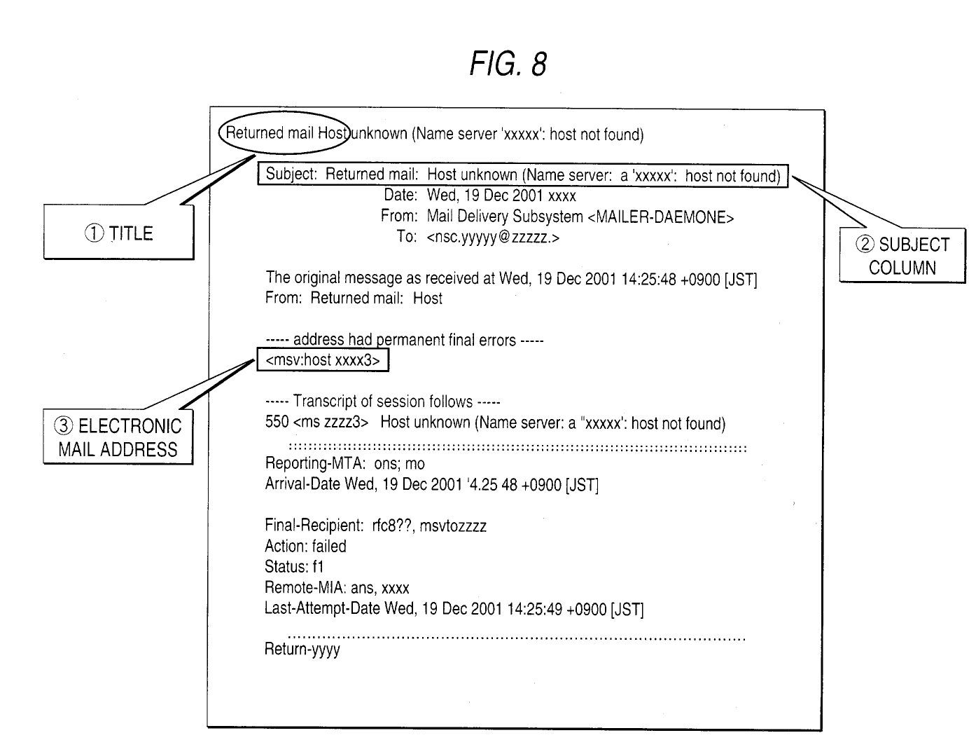

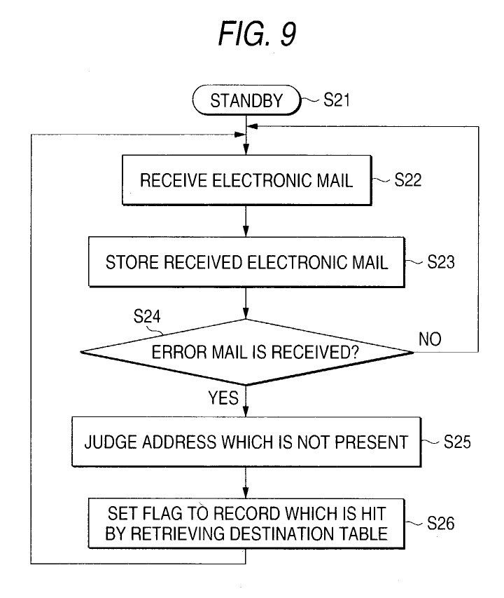

Also, in such a case that although an electronic mail was transmitted from an electronic mail communication apparatus, a destination has been deleted from this transmitted electronic mail, this fact may be alternatively notified to a user. This alternative operation may be realized as follows: That is, when such an error message of an electronic mail as indicated in FIG. 8 is transmitted from a mail server, an address corresponding to this electronic mail is extracted. Based upon this extracted address, a destination table is consulted, and a hit flag is set to such a record which hits this address, and thus, this fact may be represented to the user by applying a certain mark, or the like. A fact as to whether or not a sent electronic mail corresponds to an error mail may be judged based upon a title “Returned Mail” (1) of this electronic mail. An electronic mail address of a counter party, which should be corrected, may be judged based upon a description (3) of an error content. This judgment process flow is indicated in FIG. 9. Since a content of this flow operation shown in FIG. 9 may be readily understood from this drawing, detailed descriptions thereof are not specifically made. In the case that the electronic mail communication apparatus performs a repeating operation (for example, repeating operation executed by facsimile apparatus equipped with electronic mail communication function) of an error mail, since the electronic mail communication apparatus can judge that this error mail corresponds to which transmission mail (namely, destination of notification destination) based upon a“Subject” column (2), this content is set to the notification destination by way of a certain mode such as an electronic mail. A flag is set to the destination table in the notification destination.

As previously explained, in accordance with the data processing apparatus of the present invention, even when the communication destination terminal is the portable terminal apparatus, since the original image data is converted into such an image data which can be fitted for the display capability (for example, display size) of this portable terminal apparatus and then the converted image data is transmitted, or since such an original image data is received and thereafter is converted into the above-described image data, no specific load is given to the user. For instance, in such a case that the pixel number of the image data is reduced, this image can be overlooked one time even on the restricted display screen of the portable terminal apparatus, so that such a very convenient portable terminal apparatus can be realized. When a detailed content of this image is wanted to be viewed by the user, the original image may be acquired by this portable terminal apparatus, or by another normal terminal apparatus having the superior display capability. Also, both the communication time and the processing time may be suppressed to short time.

What is claimed is:

1. A data processing apparatus comprising:
a storage which stores first data therein;
a convert section which converts the first data into second data when a judgment is made that a destination is a portable terminal apparatus; and
a transmit section which transmits the second data to the destination;
wherein
the convert section converts the first data into the second data based upon display capability of a data display apparatus of the data display apparatus.

2. A data processing apparatus comprising:
a display;
a receive section which receives first data;
a storage which stores the first data received by the receive section; and
a convert section which converts the first data into second data based upon display capability of the display;
wherein the display displays the second data.

3. A data processing apparatus comprising:
a receive section which receives first data;
a storage which stores the first data received by the receive section;
a convert section which converts the first data into second data; and
a transmit section which transmits the second data to a transmission determination apparatus;
wherein
the convert section converts the first data into the second data based upon data display capability of the transmission destination apparatus.

4. The data processing apparatus as claimed in claim 1,
wherein
the storage stores the first data after the second data has been transmitted by the transmit section.

5. The data processing apparatus as claimed in claim 3,
wherein
the storage stores the first data after the second data has been transmitted by the transmit section.

6. The data processing apparatus as claimed in claim 1,
wherein
the convert section make the judgment based upon predetermined information as to whether or not the destination is a portable terminal apparatus; and
the predetermined information is accompanied with an address information of the portable terminal apparatus.

7. The data processing apparatus as claimed in claim 1,
wherein
the convert section make the judgment based upon a domain name of an address of the portable terminal.

8. A data processing method comprising:
storing first data;
judging whether a destination is a portable terminal;
converting the first data into second data, when the destination is judged to be a portable terminal apparatus, based upon display capability of a data display apparatus of the portable terminal apparatus; and
transmitting the second data to the destination.

9. A data processing method comprising:
receiving first data;
storing the received first data;
converting the first data into the second data based upon display capability of a data display unit; and
displaying the second data on the data display unit.

10. A data processing method comprising:
receiving first data;
storing the received first data;
converting the first data into second data based upon data display capability of a transmission destination apparatus; and
transmitting the second data to the transmission destination apparatus.

11. A computer program for controlling a computer, the program causes the computer to execute:
storing first data;
judging whether a destination is a portable terminal;
converting the first data into second data, when the destination is judged to be a portable terminal apparatus, based upon display capability of a data display apparatus of the portable terminal apparatus; and
transmitting the second data to the destination.

12. A computer program for controlling a computer, the program causes the computer to execute:
receiving first data;
storing the received first data;
converting the first data into the second data based upon display capability of a data display unit; and
displaying the second data on the data display unit.

13. A computer program for controlling a computer, the program causes the computer to execute:
receiving first data;
storing the received first data;
converting the first data into second data based upon data display capability of a transmission destination apparatus; and
transmitting the second data to the transmission destination apparatus.

14. An image data transmission apparatus comprising:
an image data producing section which produces first image data;
an image data converting section which converts the first data into second data when a judgment is made that a destination is a portable terminal apparatus; and
a transmit section which transmits the second data to the destination;
wherein
the convert section converts the first data into the second data based upon display capability of a data display apparatus of the data display apparatus.

15. The image data transmission apparatus as claimed in claim 14, wherein the image data producing section optically reads a manuscript image from a manuscript copy to produce original image data.

16. An electronic mail communication apparatus, comprising:
address add section for automatically adding an address of a received electronic mail to an electronic address notebook;
wherein
when an address of an electronic mail is added to the electronic address notebook, the address add section judges both reception capability and expansion capability of a communication destination apparatus which send the electric mail, based upon a domain of a mail address of the communication destination apparatus; and
the address add section adds the mail address to respective categories classified with respect to each of the reception capability and the expansion capability.

17. The electronic mail communication apparatus as claimed in claim 16 wherein the categories can be added by a user.

18. An electronic mail communication apparatus wherein a destination of an electronic mail is designated among addresses registered in an electronic address notebook, the apparatus comprising:
a receive section which receives an electronic mail sent from a mail server, the electric mail for notifying that a destination is not present;
an extract section which extracts information related to the destination from the received electronic mail;
an add section which adds identification information for indicating that the destination is not present to a record of the electronic address notebook based upon the extracted information; and
a display section which displays the record of the electronic address notebook on which the destination is not present based upon the identification information.
